(19) United States
(12) Patent Application Publication
(10) Pub. No.: US 2005/0068754 A1
(43) Pub. Date: Mar. 31, 2005

(54) System and method for a self aligning multiple card enclosure with hot plug capability

(75) Inventors: Joseph P. Corrado, Marlboro, NY (US); Michael J. Fisher, Poughkeepsie, NY (US); William P. Kostenko, Poughkeepsie, NY (US)

Correspondence Address: Philmore H. Colburn II;Cantor Colburn LLP, 55 Griffin Road South, Bloomfield, CT, 06002, US

(73) Assignee: INTERNATIONAL BUSINESS MACHINES CORPORATION, ARMONK, NY (US)

(21) Appl. No.: 10/671,390

(22) Filed: Sep. 25, 2003

(51) Int. Cl. H01R 12/16

(52) U.S. Cl. 361/788

(57) ABSTRACT

An exemplary embodiment is a multiple card enclosure including a mother card cage having a mother card enclosed therein and a daughter card removably positioned within the cage for connecting the daughter card with the mother card. The daughter card includes a power tab extending from a first edge defining the card and a signal connector extending from a second edge perpendicular to the first edge. The signal connector is configured to connect to the mother card for signal interconnection therebetween. A guide means is configured to guide the daughter card into the mother card cage and in signal interconnection with the mother card and is configured to provide power into and out of the daughter card via connection with the power tab.

### BACKGROUND OF THE INVENTION

Computers are customarily provided with sheet metal cage structures that contains a back plane. A back plane is a circuit board (e.g., mother card) or framework that supports other circuit boards, devices, and the interconnections among devices, and provides power and data signals to supported devices. The mother card is the main circuit card in the computer which connects to the back plane of the logic board. The computer cage structure is adapted to receive and removably support at least one and preferably a plurality of options or daughter cards (blades or nodes) which when operatively installed in their associated cage structure, upgrade the operating capabilities of the computer. For example, it is known to place an assembly, including a backplane and various circuit boards, such as a processor card, an input-output card and a so-called memory riser card, within an open cage. This forms a so-called central electronic complex (CEC) of a computer system. The cage is subsequently fixed within a computer housing.

A standard containing enclosure or cage protects the individual daughter cards and facilitates the easy insertion and removal of the daughter cards from a mother card (mother board) or back plane slot. These daughter cards may be installed in the computer during the original manufacture of the computer and or subsequently installed by the computer purchaser. The cage serves to position the circuit boards within the computer housing, and acts as an EMC (electromagnetic compatible) shield. An EMC shield allows operation in an electromagnetic environment at an optimal level of efficiency, and allows static charges to be drained to a frame ground. Moreover, the cage helps to protect the components contained therein from environmental damage, for example, vibrations, which could cause the components to fail.

Additionally, the cage is typically fixed within a so-called system chassis, which is a frame that provides further support for the cage, and which is removably stacked upon other system chassises within a system rack. The chassis may contain other components and sub-systems, such as power supplies and cooling fans, for example, which are connected to the components within the cage using cables, for instance.

A daughter card may include a relatively small rectangular printed circuit having a connecter along one side edge, a 24″×24″ node weighing over a hundred pounds, or a server, for example. The mother card or system back plane slot has a socket connector. The daughter card connector plugs into a corresponding socket connector of the mother card to operatively couple the daughter card to the mother card or system back plane slot. In order to allow the circuit boards or daughter cards to be connected to the backplane, it is also typical to position the backplane at a rear of the cage, and in a vertical position. This allows the circuit boards or daughter cards to be plugged into the card slots of the backplane through the open front, for example, of the cage.

Data processing systems in general and server-class systems in particular are frequently implemented with a server chassis or cabinet having a plurality of racks. Each cabinet rack can hold a rack mounted device (e.g., a daughter card, also referred to hereinas a node, blade or server blade) on which one or more general purpose processors and/or memory devices are attached. The racks are vertically spaced within the cabinet according to an industry standard displacement (the “U”). Cabinets and racks are characterized in terms of this dimension such that, for example, a 42U cabinet is capable of receiving 42 1U rack-mounted devices, 21 2U devices, and so forth. Dense server designs are also becoming available, which allow a server chassis to be inserted into a cabinet rack, thus allowing greater densities than one server per 1U. To achieve these greater densities, the server chassis may provide shared components, such as power supplies, fans, or media access devices which can be shared among all of the blades in the server blade chassis.

However, there is a significant problem of making multiple simultaneous connections onto a single node or blade on insertion. The problem arises from divergent needs of power and signal interconnection with the node or daughter card. The power interconnect often requires high currents and thus large, rugged conductive interfaces. These interfaces are often bolted bus bars or post in holes type interconnects which cannot support high precision assemble. The signal interconnect on the other hand requires high density pin fields that are relatively fragile and require very precise plug and guidance systems. Another problem is the need for daughter card edge real estate on high density daughter cards. Often the need for I/O and power interconnects compete for the same, limited card edges for interface connectors.

In addition, when the daughter card is removed from the cage for service, typically the connections between the daughter card and the other cage components within the cage must be manually disconnected and reconnected. This is a relatively time consuming process. Thus, there is a need for an arrangement that will allow for the removal of the daughter card for servicing, for example, which does not require manually connecting and disconnecting various electrical connectors to provide signal and power interconnection therebetween while providing an easy and reliable means to align the daughter card to make such signal and power interconnections within the cage.

### SUMMARY OF THE INVENTION

A multiple card enclosure including a mother card cage having a mother card enclosed therein and a daughter card removably positioned within the cage for connecting the daughter card with the mother card is disclosed. The daughter card includes a power tab extending from a first edge defining the card and a signal connector extending from a second edge perpendicular to the first edge. The signal connector is configured to connect to the mother card for signal interconnection therebetween. A guide means is configured to guide the daughter card into the mother card cage and in signal interconnection with the mother card and is configured to provide power into and out of the daughter card via connection with the power tab.

In an exemplary embodiment, a multiple card enclosure includes a mother card cage having a mother card enclosed therein and a daughter card removably positioned within the cage for connecting the daughter card with the mother card. The daughter card includes a power tab extending from a first edge defining the card and a signal connector extending from a second edge perpendicular to the first edge. The signal connector is configured to connect to the mother card for signal interconnection therebetween. At least one guide rail connects the daughter card within the enclosure as the daughter card is slidably disposed on the rail and guides the daughter card into the cage using the rail. The power tab extending from the daughter card is slidably received by the guide rail and allows the daughter card to properly register with the mother card. The guide rail includes a power receptacle disposed within the rail and is configured to operably provide power interconnection between the tab and a power supply when the card is plugged into the cage. The guide rail aligns the tab relative to the receptacle for power interconnection therebetween and guides the signal connector to the mother card for signal interconnection therebetween by guiding the tab within the rail when the card is slid into the cage.

### BRIEF DESCRIPTION OF THE DRAWINGS

Referring now to the exemplary drawings wherein like elements are numbered alike in the several FIGURES:

FIG. 1 is a perspective view of an exemplary embodiment of the multiple card enclosure illustrating one daughter card enclosure interfacing with a midplane for signal interconnection and a guide rail for power interconnection therebetween;

FIG. 2 is a perspective view of the exemplary daughter card enclosure of FIG. 1 with a stiffener removed therefrom;

FIG. 3 is a perspective view of the exemplary daughter card enclosure of FIG. 1 illustrating a top portion thereof with bus bars extending to top mounted power guide rails;

FIG. 4 is an enlarged partial perspective view of two exemplary power guide rails secured to the multiple card enclosure, each configured to guide and provide power to a corresponding daughter card;

FIG. 5 is an enlarged partial top view of one of the guide rails of FIG. 3 illustrating three power louver connection forks for receiving a corresponding power tab extending from a daughter card; and

FIG. 6 is a perspective view of one side of the power connection fork of FIG. 4 illustrating three sets of power louvers for connection with three respective power tabs.

### DETAILED DESCRIPTION OF THE PREFERRED EMBODIMENTS

The invention will now be described in more detail by way of example with reference to the embodiments shown in the accompanying figures. It should be kept in mind that the following described embodiments are only presented by way of example and should not be construed as limiting the inventive concept to any particular physical configuration.

Further, if used and unless otherwise stated, the terms “upper”, “lower”, “front”, “back”, “over”, “under”, and similar such terms are not to be construed as limiting the invention to a particular orientation. Instead, these terms are used only on a relative basis.

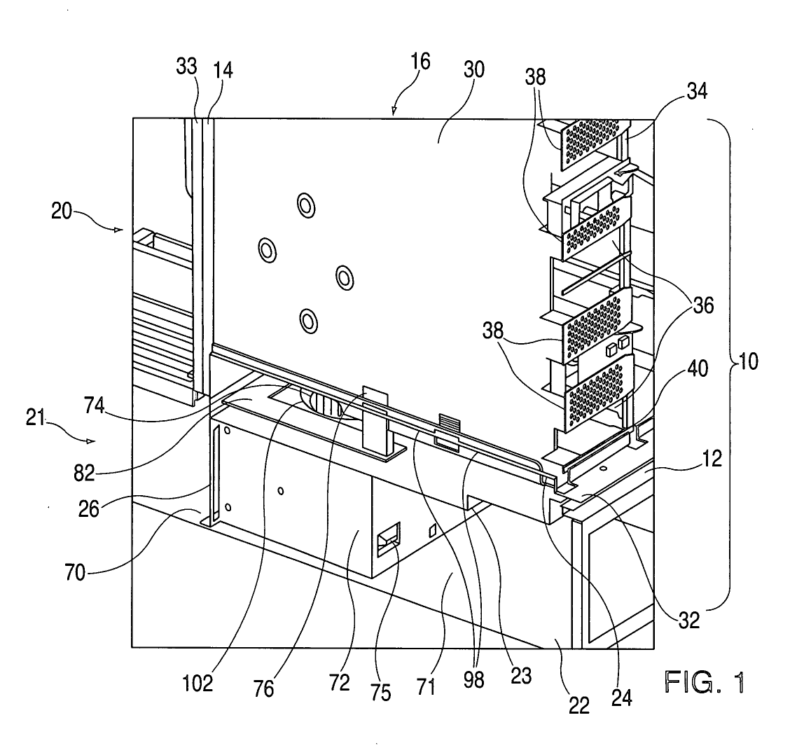

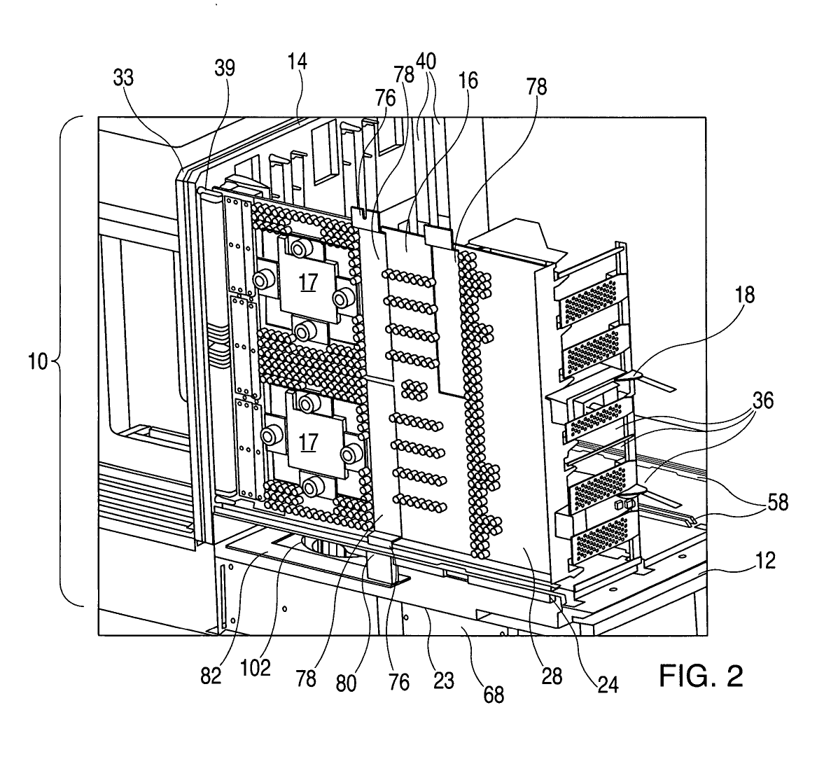

FIGS. 1 and 2 illustrate an exemplary embodiment of the invention, which includes a so-called central electronics complex 10 (CEC) of a computer system. The CEC 10 is comprised of an enclosure (such as a cage 12), a backplane or midplane 14 as illustrated, and a circuit board or daughter card, such as a blade or node 16 having two processor multi-chip modules 17, 256 GB memory on 16 cards (not shown), an input/output (I/O) card 18 (FIG. 2), and a control multiplexer card (not shown), for example, attachable to the backplane 14.

As shown, the cage 12 has a box shape with a generally rectangular cross-sectional profile, and is formed of two cavities on one side of midplane 14, generally shown at 20 and 21, while three cavities are defined on an opposite side of midplane 14 with generally horizontal, spaced apart walls 22, 23, and 24 joined together by generally upright, midwall 26 extending from wall 24. Wall 22 defines a bottom floor defining cage 12. Wall 23 extends to midwall 26 defining a bus bar access area discussed more fully herein. Wall 24 defines a floor defining a cavity in which a plurality of daughter cards 16 may be disposed and interconnected with midplane 14. The walls 22, 23, and 24 define spaces within the cage 12, which contain air, power, and docking systems for a plurality of daughter cards 16 installed in the cage.

The cage 12 is dimensioned to accommodate the midplane 14 and a plurality of daughter cards 16, (four shown) as will be subsequently described. Moreover, the cage 12 is preferably comprised of sheet metal, which can be easily manipulated to form the walls 22, 23, 24, 26, although other materials, such as plastic, may also be used. However, it is preferable that the material used to form the cage 12 be conductive, so that the cage can serve as an EMC shield.

As best shown with reference to both FIG. 1 and FIG. 2, the backplane or midplane 14 is a generally planar, rectangular structure, and is accommodated within the cage 12 so that its major surfaces are substantially vertical and essentially perpendicular to the walls 22, 23, and 24 of the cage. Moreover, the daughter card 16 is comprised, for example, of a printed circuit board 28 (PCB) (FIG. 2), and a stiffener panel 30 (FIG. 1) disposed beneath (i.e., on one side of) the printed circuit board 28. An insulator panel, not shown, may also be provided between the stiffener panel 30 and the printed circuit board 28.

The stiffener panel 30 is connectable to the cage 12, for example, by fastening the stiffener panel to a flange 32 disposed on a lower bottom edge of walls 24. For example, the stiffener panel 30 can be screwed, bolted or welded to the flange 32. Other means for connecting the stiffener panel 30 to the cage 12 are within the scope of the present invention. When connected, the backplane 14 partially divides the cage 12 in two, and serves as a partial divider of the cage, with the printed circuit board 28 perpendicular thereto.

Preferably, an end distal from a backplane stiffener panel 33 has a tailstock 34 disposed thereon. As is known, a tailstock is a fixture or bezel that provides physical support for the associated electrical device (for example, the I/O card 18), and which provides for a limited amount of electromagnetic radiation shielding and is configured to be reworkable.

The tailstock 34 is provided with a plurality of apertures 36, which form ports that allow various external peripherals to be connected to the backplane 14. For example, in the exemplary illustrated embodiment, the tailstock 34 is provided with eight such ports (FIG. 2). However, the number and size of the apertures 36 can be modified without departing from the spirit and scope of the present invention.

The tailstock 34 is preferably tailored to allow it to be fastened to stiffener 30 (shown in FIG. 1). For example, in the illustrated exemplary embodiment, the tailstock 34 is operably fastened to stiffener 30 via four apertures 38 in tailstock 34 aligned with corresponding threaded apertures configured in stiffener 30. When the daughter card 16 is received within cage 12 (as will be more fully explained in the pages that follow), the portions of the tailstock 34 that extend to wall 24 can be fastened thereto. This secures the card 16 within the cage 12, and prevents fretting of any electrical connections between the backplane 14, and other system components disposed within the cage 12, for example. As is known, fretting is a phenomenon in which surface damage occurs when metal contacts are subjected to microvibrations.

Each daughter card 16 is generally planar, rectangular structures, with lengths that are substantially the same as their heights, as illustrated, but not limited thereto. As previously mentioned, the cage 12 can then be advantageously tailored in the same manner (with a length that is about the same as its height), so as to receive the respective cards 16 therein with a minimum amount of wasted space.

When installed in the cage 12, the cards 16 are essentially parallel to each other, and essentially perpendicular to the major surfaces of the backplane 14. However, other orientations may be possible, within the scope of the present invention.

The daughter card 16 is preferably removably coupled to the backplane 14 by inserting a known corresponding plug connector, such as a dual row of full edge length very high density metricinterconnector (VHDM) 39 (not shown in detail FIG. 2) on the respective card into an associated backplane card slot 40 (FIG. 2). However, other suitably configured plug connectors are contemplated and is not limited to VHDM 39. As will be appreciated, since the cage 12 is open at its front, each card 16 is inserted through the open front and moved in a horizontal vertical direction until the cards engage with the associated card slots 40 and power interconnects to be discussed more fully below.

As illustrated in FIGS. 1 and 2, the backplane 14 is adapted to receive and electrically interconnect a plurality of daughter cards 16. For example, the illustrated backplane 14 is adapted to receive four cards 16.

Further, and as illustrated best in FIG. 2, each daughter card 16 can accommodate a plurality of electrical components, for example, two MCMs 17, 256 GB memory on 16 cards (not shown), eight concurrently maintainable I/O hub cards (two shown installed) and a control multiplexer card (not shown).

Although the present embodiment has been described in connection with a daughter card 16 having a pair of MCMs 17, it is contemplated that the same inventive scheme can be utilized with other types of circuit boards. Moreover, it is also contemplated that the respective cards will be specifically tailored for use with the cage 12. For example, in the above-described exemplary embodiment, the plug connector of the daughter card is disposed symmetrically, that is, along a full length of the edge of the card.

As will be appreciated, since the cards 16 may be modified by the user, it is advantageous if the cards be easily accessible. As previously discussed, each card is accessed through the open front of the cage 12. Conventionally, the cages are each positioned within a respective chassis, each having an open top, with the respective chassises and cages being stacked upon each other. As such, in order to access a cage within a lower positioned chassis, it had conventionally been necessary to remove the associated chassis from a rack.

As best shown in FIG. 2, in order to facilitate the removal of the card 16 from the cage 12, the card is advantageously slidably disposed on at least one guide rail 58 which is operably connected to wall 24 of cage 12, for example, and registered to midplane 14. Thus, when it is desired to access the components disposed on the card 16, the card is simply slid in a horizontal direction out of the cage 12.

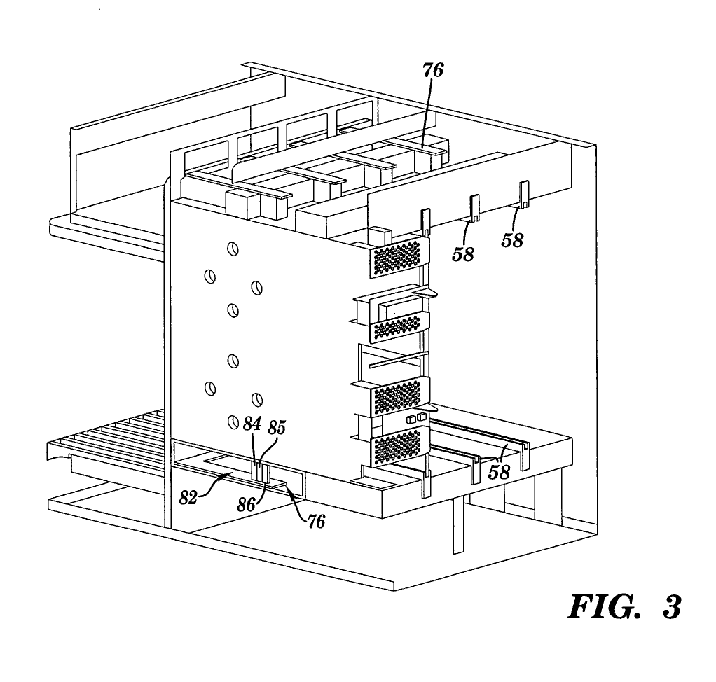

Preferably with reference to FIG. 3, there are two parallel guide rails 58 for each corresponding card 16, with one of the guide rails 58 being disposed under a bottom edge defining card 16, and the other one of the guide rails 58 being disposed above a top edge defining card 16 opposite the bottom edge. It will be recognized that FIG. 3 illustrates four pairs of rails 58 for receiving and guiding four respective daughter cards toward midplane 14 for signal interconnection therewith via the two rows of VHDM 39.

In the illustrated exemplary embodiment, and as best shown in FIGS. 2, the cage 12 has one or more accessible power supplies 68 disposed therein, for example disposed against wall 22 defining a bottom of cage 12. Moreover, and as best shown in FIG. 1, the cage is separated using wall 26 in a middle region 70 defining a front region 71, in which the power supplies 68 are disposed, and a cooling unit 72 adjacent wall 26 of the cage 12. The cooling unit 72 disposed in front region 71 of the cage 12 may be provided cooling fans 74 and a cable connection 75 for coupling the power supply and cooling unit together, and any other desired components.

Preferably, in order to facilitate the electrical connections between the components of the cage 12 and those disposed on card 16, the cage is provided with an autodocking feature that automatically couples the backplane 14, for example, with the dual row of VHDM 39 within the cage 12. In the illustrated exemplary embodiment, the autodocking feature includes at least one power tab 76 extending from a middle portion of card 16 (shown in FIG. 2) guidably received in guide rail 58. Power tab 76 operably extends from a corresponding bus 78 configured to provide power to components of the card 16. However, it will be noted that power tab 76 may be a finger extending from a card edge defining daughter card 16 in some instances. A corresponding receptacle 80 is integrated in guide rail 58 for electrical connection with tab 76 to provide an electrical power interconnection therebetween when card 16 is in signal interconnection with backplane 14 via VHDMs 39. The receptacle 80 is positioned within the preferably U-shaped guide rail 58 and is electrically connected to a bus bar 82 extending to one of the power supplies 68 for providing electrical power thereto. Moreover, the bus bar 82 is disposed on wall 23, and includes one or more receptacles 80 that are positioned in registration with an opening formed in guide rail 58. The projecting receptacles 80 are arranged in registration with respective ones of the tabs 76, each extending from a corresponding vertically oriented bus 78. In this manner, a continuing bus structure from tab 76 to bus 78 leads to more efficient power distribution on card 16 because less copper is needed and because of a two edge feed that does not utilize any real estate from perpendicular edges used for signal interconnections. In other words, this configuration allows the premium midplane edge and opposite tail stock real estate to be used solely for signal interconnect, while the remaining edges are utilized for power interconnection. In this manner, the need to conduct power to MCMs 17 proximate signal interconnect real estate is eliminated, thereby reducing the thickness of card 16, as will be appreciated by one skilled in the pertinent art.

When the card 16 is fully received within the cage 12, the projecting receptacles 80 engage with the respective tabs 76 providing power interconnection therebetween, thereby coupling the backplane 14 with the other components disposed on card 16 and in signal interconnection therebetween on a separate card edge independent of edges substantially perpendicular thereto used for power interconnection. Likewise, when the card 16 is slid out of the cage 12, the projecting receptacles 80 automatically disengage with the respective tabs 76, thereby electrically uncoupling the backplane 14 from the other components disposed on card 16. This arrangement advantageously eliminates the need to manually disconnect various electrical connections between the cage and the chassis, when the cage is removed. Of course, it is contemplated that the backplane can be coupled to the other components in the chassis using other arrangements, without departing from the spirit of the invention.

Furthermore, the power guide rails 58 are configured and aligned to ensure that each card 16 is properly positioned and automatically aligned relative to signal interconnection with backplane 14 during the autodocking procedure. This arrangement allows for float and staging (such as just before end-of-travel-kick-up) for signal connector alignment at the midplane edge of card 16. Thus, the respective electrical connections (e.g., power and signal) can be coupled together automatically, reliably, and quickly.

As will be appreciated, this configuration advantageously uses gravity to help retain the cards 16 in position. That is, the weight of the respective cards 16 urges the cards in a direction toward the power guide rails 58. Thus, each card 16 is less likely to inadvertently disengage with a respective lower receptacle 80 providing power to bus bar 78 via power tab 76 avoiding power interruptions thereby. It will be recognized that such connections can be for multiple voltages and at the top edge, bottom edge, or both edges of card 16. In an exemplary embodiment, tabs 76 are preferably configured of staged width such that tabs 76 are narrower as they approach a midplane edge of card 16. In this manner, tabs 76 are easily wedged into power connection with a corresponding receptacle 80 when card 16 is slid toward backplane 14.

Although each receptacle 80 has been described as being serially aligned within each rail 58, it is also contemplated that receptacles 80 may be aligned in parallel or be concentric with respect to one another and rail 58. In addition, it is further contemplated that each receptacle may be a staged receptacle such that one side defining each power fork is at a first voltage level, while an opposite side is at a second voltage different form the first voltage. In this manner, a receptacle may provide staged power (e.g., ground and +V) to a corresponding side defining a power tab 76, wherein each side is insulated from the opposing side at a different potential. For instance, power tab 76 may be a laminated power tab.

Receptacle 80 receives power from supply 68 via a bus bar 82 connection therebetween, however, it is contemplated that a conductive wire may be employed as well. Bus bar 82 preferably extends from power supply 68 and is disposed on wall 23 before extending in electrical communication with receptacle 80 extending through guide rail 58.

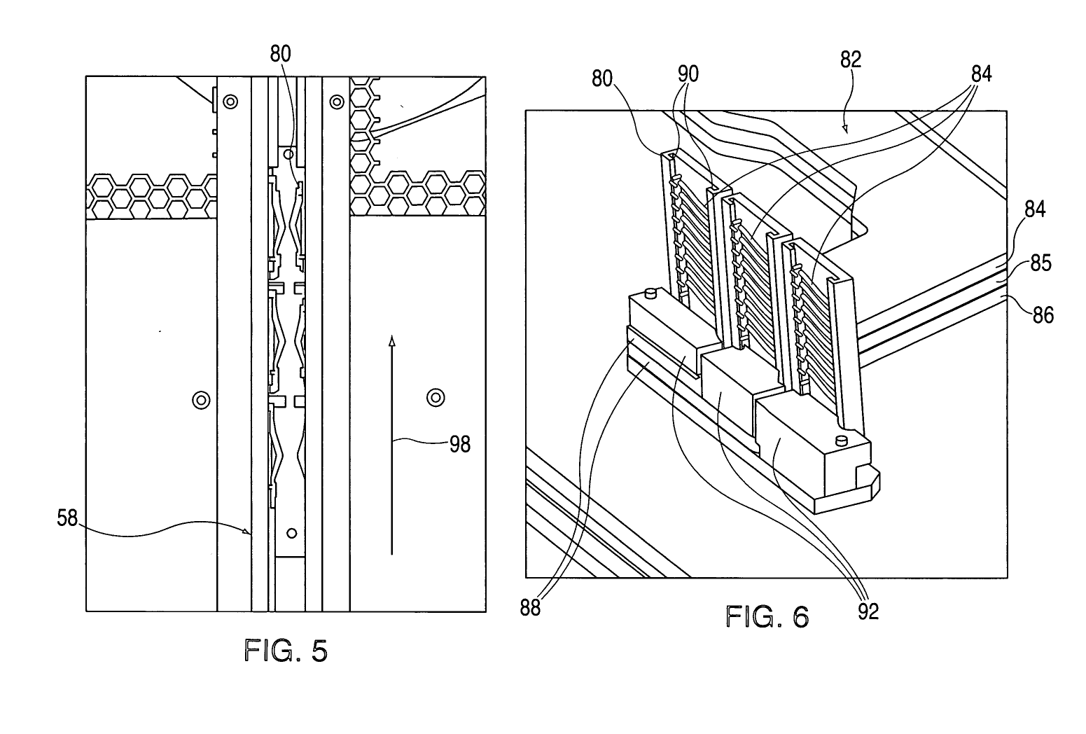

In an exemplary embodiment with reference to FIGS. 5 and 6, bus bar 82 includes 3 bus bars 84, 85, 86 stacked upon each other as illustrated in FIG. 6. Each bus bar 84-86 is insulated from the other two via an insulation layer 88 disposed between contiguous bus bars 84-86. Each bus bar 84-86 is preferably configured to supply receptacle 80 three different voltages for card 16, however, similar voltage or current levels are also contemplated. More specifically, receptacle 80 is configured to receive three individual voltages and provide the same to corresponding tabs 76 and bus 78. In an exemplary embodiment, receptacle 80 is configured as a three way power connection fork for sliding power tabs 76 therethrough and electrical connection therewith. In particular, contact technology such a power “louvers” 84 as illustrated is commercially available and contemplated. However, other types of contact technology are contemplated to make electrical contact with both sides of each power tab 76. One half of such a power connection fork with corresponding louvers 84 for each tab 76 is illustrated in FIG. 6 and are aligned for connection with a corresponding bus bar 84-86. Receptacle 80 is preferably configured with a pair of grooves 90 for each set of louvers 84 to receive and retain the same via grooves 90. Further, receptacle 80 is preferably configured to receive bus bar assembly 82 and maintain isolation between contiguous bus bars 84-86 with complementary configured blocks 92 while providing electrical connection to a respective set of louvers 84. Although electrical connection therebetween each set of louvers 84 and corresponding bus bar 84-86 is not explicitly illustrated, such connection is well known in the pertinent art. FIG. 5 exemplifies a top view of three contiguous sets of stacked louvers for connection with each side of a corresponding power tab 76 disposed within power guide rail 58.

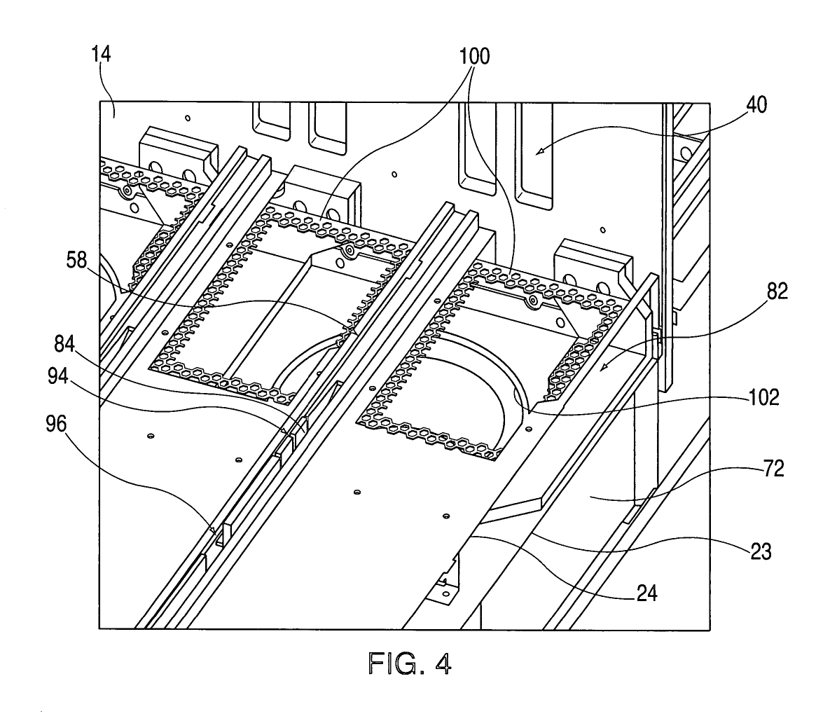

More specifically with reference to FIGS. 4 and 5, receiving fork portions 94 of receptacle 80 extend through a complementary configured slot 96 in guide rail 58 such that power guide rails still allow guidance of card 16 for connection with backplane 14 while allowing power connection with receptacle 80 when properly aligned therewith. Arrow 98 indicates a direction of travel of card 16 and tabs 76 for guiding the same toward backplane 14 for signal connection therewith while tabs 76 (FIG. 3) are guided and eventually aligned in a corresponding set of louvers 84 for power connection thereto (FIG. 5).

Still referring to FIG. 4, it will be recognized that at least a portion defining a length of each power guide rail 58 depends from a top surface of wall 24 while a remaining portion is configured to fit within a slot (shown generally at 98 in FIG. 1) configured in wall 24 for proper positioning of rail 58 therein and with respect to corresponding slots 40 in backplane 14. Rail 58 is preferably made of an insulative material, such as molded plastic. Wall 24 further includes grating 100 in corresponding cutouts (three partially shown) corresponding with apertures 102 configured in wall 23 (two partially shown in FIG. 4) that are aligned with fans 74 so that air may flow therefrom between cards 16 for cooling thereof (FIG. 1). In this configuration, a high volume of air flow is possible.

The above described embodiments get power into and out of the daughter card, while providing for a pluggable, concurrently maintainable daughter card packaged as an extremely dense, high power (e.g., about 2000 Amperes of logic power with a low voltage drop and low impedance), air cooled, heavy node. The above configuration having two full length VHDMs 39 further provides 3120 high speed signal I/O to midplane 14 while maintaining an 18U cage. The power guide rail system disclosed herein does not interfere with midplane connector alignment, float range, and vertical kick proximate an end of node guidance to allow nominal centering on midplane guide posts.

The current embodiments shown with respect to the figures demonstrate cage 12 with one daughter card 16 disposed therein and guide rails for three more. However, in other embodiments, more or less than four daughter cards 16 are contemplated, and not limited thereto. The figures show a configuration that allows the daughter card 16 to be mounted inside cage 12, side-by-side relative to one another. The daughter cards 16 are co-planar within the CEC enclosure. Multiple technologies associated with the multiple daughter cards 16 can be interchanged with a single mother card in a logic board. The multiple card enclosure provides for serviceability and adaptability of the system while getting power into and out of the daughter card via a guide rail without affecting the associated real estate and interconnection between the midplane edge of card 16 and the midplane 14.

As computer architectures evolve into high density symmetric multi-processing (SMP) configurations built on large nodes or blades (e.g., larger daughter cards), the plugging and interconnect of these nodes/blades becomes significantly more difficult. The above described configuration discloses an integrated guide rail system configured to both guide and retain the node or blade as well as provide a high current electrical interconnect required to provide power to the node or blade. The integrated guide rail system occupies card edge real estate different from that required for the high density signal interconnects allowing for premium card edge real estate to be used for SMP signal interconnect. Further, by disposing the power interconnects proximate a middle portion of the card, the guide rail system provides enough float for the more sensitive connection between the high density signal interconnects and the system backplane. The above disclosed configuration also eliminates creation of localized high currents on the card common with traditional power interconnect system and methods.

Moreover, the above described configuration allows for multiple voltages to be distributed along a length guiding the system guide rail, however, it is contemplated that the power interconnects may be oriented in parallel or concentric instead of being serially oriented.

Lastly, the above described configuration combines a node/blade guide with one or more power interconnects thereby reducing load coupling from multiple interconnects. In addition, configuring the power tabs as staged power interconnects enhance this endeavor.

While preferred embodiments have been shown and described, various modifications and substitutions may be made thereto without departing from the spirit and scope of the invention. Accordingly, it is to be understood that the present invention has been described by way of illustration and not limitation.

1. A multiple card enclosure comprising:
a mother card cage having a mother card enclosed therein;
a daughter card removably positioned within said cage for connecting said daughter card with the mother card, said daughter card having a power tab extending from a first edge defining said daughter card and a signal connector extending from a second edge perpendicular to said first edge, said signal connector configured to connect to said mother card for signal interconnection therebetween; and
a guide means for guiding said daughter card into said mother card cage and in signal interconnection therewith, said guide means configured to provide power into and out of said daughter card via connection with said power tab.

2. The enclosure of claim 1, wherein said guide means includes a receptacle integrated therewith, said receptacle aligned with said power tab and provides power to said power tab when said signal connector is operably connected to said mother card.

3. The enclosure of claim 2, wherein said guide means are disposed within said cage on at least one of one side and opposite sides of said daughter card having at least one corresponding power tab extending therefrom.

4. A multiple card enclosure comprising:
a mother card cage having a mother card enclosed therein;
a daughter card removably positioned within said cage for connecting said daughter card with the mother card, said daughter card having a power tab extending from a first edge defining said daughter card and a signal connector extending from a second edge perpendicular to said first edge, said signal connector configured to connect to said mother card for signal interconnection therebetween; and
at least one guide rail connecting said daughter card to said enclosure, said daughter card being slidably disposed on said rail, and being guidable into said cage using said rail; said at least one guide rail affixed to said cage, said power tab extending from said daughter card being slidably received by said guide rail to allow said daughter card to be slid into and out of said cage, said guide rail having a power receptacle disposed within said rail, said receptacle configured to operably provide power interconnection between said tab and a power supply when said daughter card is plugged into said cage;
wherein said guide rail aligns said tab relative to said receptacle for power interconnection therebetween, and guides said signal connector to the mother card for signal interconnection therebetween by guiding said tab within said rail when said daughter card is slid into said cage.

5. The enclosure of claim 4, wherein said at least one guide rail includes two guide rails, each being disposed within said cage and on opposite sides of said daughter card having at least one corresponding tab extending therefrom.

6. The enclosure of claim 4, wherein said power tab is operably connected to said power supply via at least one of an electrical bus and a conductive wire connected therebetween.

7. The enclosure of claim 4, wherein said power tab includes a plurality of power tabs aligned to electrically interconnect with a corresponding receptacle extending within said at least one rail.

8. The enclosure of claim 7, wherein each tab of said plurality of power tabs operably receives a unique voltage via a corresponding bus or wire connected to a respective receptacle disposed with said at least one rail.

9. The enclosure of claim 4, wherein said power tab is operably connected to a bus bar extending across said daughter card, said bus bar configured to provide electrical power to electrical components disposed on said daughter card.

10. The enclosure of claim 8, wherein said receptacle includes a power connection fork configured to receive two sides defining said tab and electrically coupled to said corresponding bus.

11. The enclosure of claim 10, wherein said power connection fork is a power louver electrically coupled to said corresponding bus.

12. The enclosure of claim 8, wherein said corresponding bus includes a plurality of stacked busses insulated from one another via an insulative layer.

13. The enclosure of claim 7, wherein said plurality of power tabs extend from a middle portion of said daughter card from at least one of a top and a bottom of said daughter card, said plurality of tabs extending from a middle portion of said daughter card provide a float range for proper alignment of said signal connector to said mother card.

14. The enclosure of claim 4, wherein said daughter card includes a reworkable EMC tailstock opposite said signal connector.

15. A central electronics complex of a computer system, comprising:
a cage configured to be received in a rack;
a power supply disposed in said cage, said power supply configured to provide electrical power therein;
a backplane disposed in said cage, said backplane including a mother card having at least one card slot on a surface thereof;
a plurality of daughter cards removably positioned within said cage, each daughter card configured to connect with a corresponding card slot in said mother card, said each daughter card having a power tab extending from a first edge defining said each daughter card and a signal connector extending from a second edge perpendicular to said first edge, said signal connector configured to connect to said mother card for signal interconnection therebetween; and
at least one guide rail connecting said each daughter card to said cage, said each daughter card being slidably disposed on said rail, and being guidable into said cage using said rail; said at least one guide rail affixed to said cage, said power tab extending from said each card being slidably received by said guide rail to allow said each daughter card to be slid into and out of said cage, said guide rail having a power receptacle disposed within said rail, said receptacle configured to operably provide power interconnection between said tab and said power supply when said each daughter card is plugged into said cage;
wherein said guide rail aligns said tab relative to said receptacle for power interconnection therebetween, and guides said signal connector to the slot of the mother card for signal interconnection therebetween by guiding said tab within said rail when said daughter card is slid into said cage.

16. The central electronics complex of claim 15, wherein said at least one guide rail includes two guide rails, each being disposed within said cage and on opposite sides of said daughter card having at least one corresponding tab extending therefrom.

17. The central electronics complex of claim 15, wherein said power tab is operably connected to said power supply via at least one of an electrical bus and a conductive wire connected therebetween.

18. The central electronics complex of claim 15, wherein said power tab includes a plurality of power tabs aligned to electrically interconnect with a corresponding receptacle extending within said at least one rail.

19. The central electronics complex of claim 18, wherein each tab of said plurality of power tabs operably receives a unique voltage via at least one of a corresponding bus and a conductive wire connected to a respective receptacle disposed with said at least one rail.

20. The central electronics complex of claim 15, wherein said power tab is operably connected to a bus bar extending across said daughter card, said bus bar configured to provide electrical power to electrical components disposed on said daughter card.

21. The central electronics complex of claim 19, wherein said receptacle includes a power connection fork configured to receive two sides defining said tab and electrically coupled to said power supply.

22. The central electronics complex of claim 21, wherein said power connection fork is a power louver electrically coupled to said power supply.

23. The central electronics complex of claim 19, wherein said corresponding bus includes a plurality of stacked busses insulated from one another via an insulative layer.

24. The central electronics complex of claim 18, wherein said plurality of power tabs extend from a middle portion of said daughter card from at least one of a top and a bottom of said daughter card, said plurality of tabs extending from a middle portion of said daughter card provide a float range for proper alignment of said signal connector to said mother card.

25. The central electronics complex of claim 15, wherein said daughter card includes a reworkable EMC tailstock opposite said signal connector.
